(19) United States
(12) Patent Application Publication
(10) Pub. No.: US 2008/0074880 A1
(43) Pub. Date: Mar. 27, 2008

(54) Apparatus and method for removing heat from plant growth light bulbs

(76) Inventors: Stephen B. Keen, Elgin, TX (US); Thomas E Marek, Austin, TX (US)

Correspondence Address: RICK B. YEAGER, ATTORNEY, 10805 MELLOW LANE, AUSTIN, TX, 78759, US

(21) Appl. No.: 11/524,572

(22) Filed: Sep. 21, 2006

(51) Int. Cl. F21V 29/00

(52) U.S. Cl. 362/294

(57) ABSTRACT

Water or air is directed through a hood for providing cooling to one or more light bulbs used in growing plants in greenhouses and hydroponic applications so that the plants are not damaged by excessive heat. A water recirculation system with a reservoir and a pump which provides a flow of cooling water through tubing to the hood. The hood provides a housing and a tube which contains one or more light bulbs which can be accessed or replaced through an end of the tube which projects through the housing. Various shapes and sizes of hoods hold various volumes of water ranging from about 0.5 to 3 gallons. A pressure relief valve protects against excessive pressure in the hood. Various reflector housing shapes and reflectors direct light to plants.

### FIELD OF THE INVENTION

The current invention relates to a method and apparatus for light bulb heat dissipation devices. In particular, the invention relates to a circulating liquid cooling device and method for greenhouses and hydroponic applications.

### BACKGROUND—PRIOR ART

The availability of light is a major factor in the ability to grow plants in greenhouse or hydroponic applications. Typically, very strong lights, such as 1000 watt bulbs are used for these applications. It is desirable to remove heat from the vicinity of these bulbs in order to avoid damage to plants.

The intensity of light on a given surface area drops by the square of the distance from the light source. It is desirable to place the light source close to the plant in order to direct light efficiently to the plant. The strong lights generate large amounts of heat that can damage the plants. Therefore it is usually necessary to provide a cooling device for the bulbs to remove heat so that the bulbs may be placed in reasonable proximity to the plants.

The prior art includes air cooled and water cooled devices.

### Hydro-Coil

The Hydro-Coil is a handcrafted a water cooled tubular glass coil made from high temperature borosilicate glass. It is fitted over a High Intensity Discharge (HID) lamp. In operation, water is pumped through the vessel. The water absorbs the radiant heat emitted by the lamp. The retail price for the coil is about $390.

The device is typically used in combination with a reservoir kit such as a 20 Gallon reservoir, a submersible pump, and ½″ tubing. A water chiller may be added to obtain additional cooling.

U.S. Pat. No. 5,147,130

U.S. Pat. No. 5,147,130 issued to Watanuki on Sep. 15, 1992 for “Cooling liquid recirculation system for light source unit” describes a cooling liquid recirculation system with walls of transparent jacket tubes for cooling a mercury-vapor lamp, The jacket tubes are provided separately from the lamp, and are formed in optical filters to decrease the temperature of an object to be illuminated. A recirculation unit of cooling liquid for recirculation of the jacket tubes is connected through an elastic duct to a light source unit such as a mercury-vapor lamp. These components are movable for practical use.

U.S. Pat. No. 5,504,666

U.S. Pat. No. 5,504,666 issued to Carmichael on Apr. 2, 1996 for “Light bulb cooling jacket and heat dissipation system” describes a light bulb cooling jacket which is adapted to confine a light bulb in a space through which cooling liquid, such as water, may be circulated. The light bulb cooling jacket includes a shell having a rim, the rim defining an opening in the shell. A stopper fits in the opening in the shell and seals against the rim of the shell. The stopper has an aperture in it. The aperture is adapted to receive a portion of a light bulb, which is held and sealed in place in the aperture. The means employed to hold the bulb in place is adapted to engage a generally cylindrical portion of the light bulb, such as the neck of a standard 1000 W bulb. An important characteristic of the invention that follows from this construction is that the light bulb cooling jacket may be used with a variety of standard high intensity light bulbs. Ports are provided in the stopper for introducing and withdrawing cooling liquid from the space enclosed by the shell and the stopper.

U.S. Pat. No. 6,595,662

U.S. Pat. No. 6,595,662 issued to Wardenburg on Jul. 22, 2003 for “Double-walled grow light housing with air flow cooling system” describes a grow light having an exterior shell with an air inlet and a hot air exhaust outlet, and a specular interior insertable into the shell. The sides of the specular insert are spaced apart from the walls of the shell so as to form a double-walled housing having air cooling chambers and vents which facilitate the movement and exhaust of air heated by high intensity light bulbs.

### SUMMARY OF INVENTION

The present invention provides improved methods and apparatus for providing liquid or air fluid cooling to grow lights.

In one embodiment, a water recirculation system is provided which includes a reservoir and a pump which provides a flow of cooling water through tubing to a cooling hood. The hood provides a housing and a tube which contains one or more light bulbs. Each light bulb can be accessed or replaced through an end of the tube which projects through the housing. In one example, a relatively large volume of coolant fluid is contained between the housing and the outside of the tube. In one example, the fluid is approximately 3 gallons of water. The fluid volume provides a safety factor during operation so that the bulb may continue to operate for some period after a pump failure. In other examples, smaller hoods are used to reduce the volume of water and thereby reduce the weight of the device. A pressure relief valve may be provided at or near the hood to prevent excessive pressure in the cooling hood.

In another embodiment, either water or air coolant may be used.

In another embodiment, a cylindrical cooling device is provided, where one or more light bulbs are placed within an inner cylinder, and water or other coolant is circulated between the inner cylinder and an outer cylinder. In one example, these cylinders are glass, and end caps are provided to seal the annular space between the cylinders, to provide hose connections to supply and return coolant to the space, to suspend or otherwise support the device, and to permit easy access to change the light bulbs. In one example, the device is designed with inlet and outlet ports located on the upper end of the device so that coolant is maintained in the device, and the device is less likely to shatter from the re-introduction of coolant against a hot inner cylinder. A high pressure relief valve is typically provided as an additional safety feature.

### BRIEF DESCRIPTION OF DRAWINGS

FIG. 1 is a perspective view of a Hydro-coil prior art cooling device.

FIG. 2 is a cross section view of the prior art device of U.S. Pat. No. 5,147,130.

FIG. 3 is a perspective view of the prior art device of U.S. Pat. No. 6,595,662.

FIG. 4 is a perspective view of an example hood device.

FIG. 5A is a top view of the first end of the hood of FIG. 4.

FIG. 5B is a side view of the first end of the hood of FIG. 4.

FIG. 6 is a cross section view showing a variety of shapes for the hood housing.

FIG. 7 is a perspective view of an example hood device with two light bulbs.

FIG. 8 is a perspective view of a double cylinder coolant device.

FIG. 9 is a front view of an end cap for the double cylinder coolant device of FIG. 8.

FIG. 10 is a side view of a hood device.

FIG. 11 is a cross section view of the hood device of FIG. 10.

FIG. 12 is a bottom view of the hood device of FIG. 10.

FIG. 13 is a schematic showing fluid and electrical connections to a hood and coolant recirculation system.

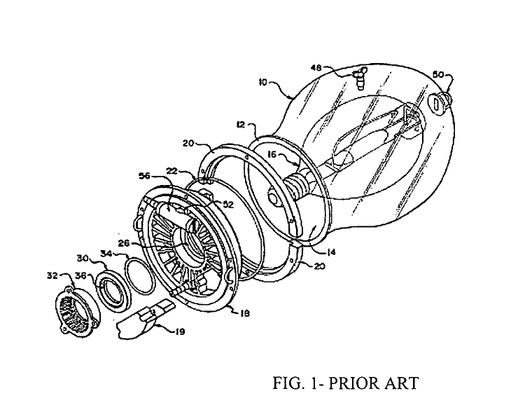

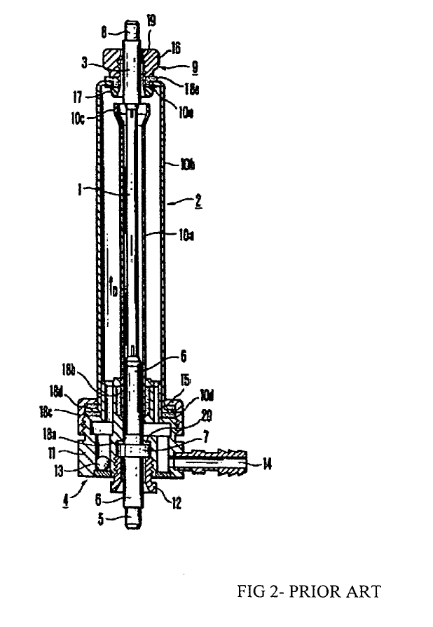

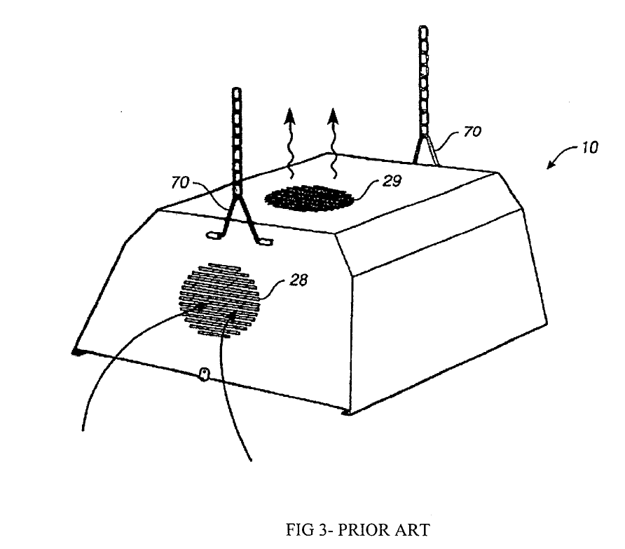

### DETAILED DESCRIPTION OF EMBODIMENT

### Water Cooled Hood

One embodiment of the current invention is the Hydroflector™ water-cooled hood. This embodiment provides a hood which can retain coolant to reduce the likelihood of shattering glass elements caused by introducing or re-introducing coolant in the vicinity of a hot lamp. The retention of coolant in the hood in the event of pump or piping failure provides a safety feature. The relatively large volume of coolant will remove heat from a lamp with only a slow temperature rise. As coolant flow is reestablished, there is less shock to the system. This embodiment also provides a good thermal efficiency of heat removal, and a high growth efficiency for plants which receive light with a minimum of extra heat.

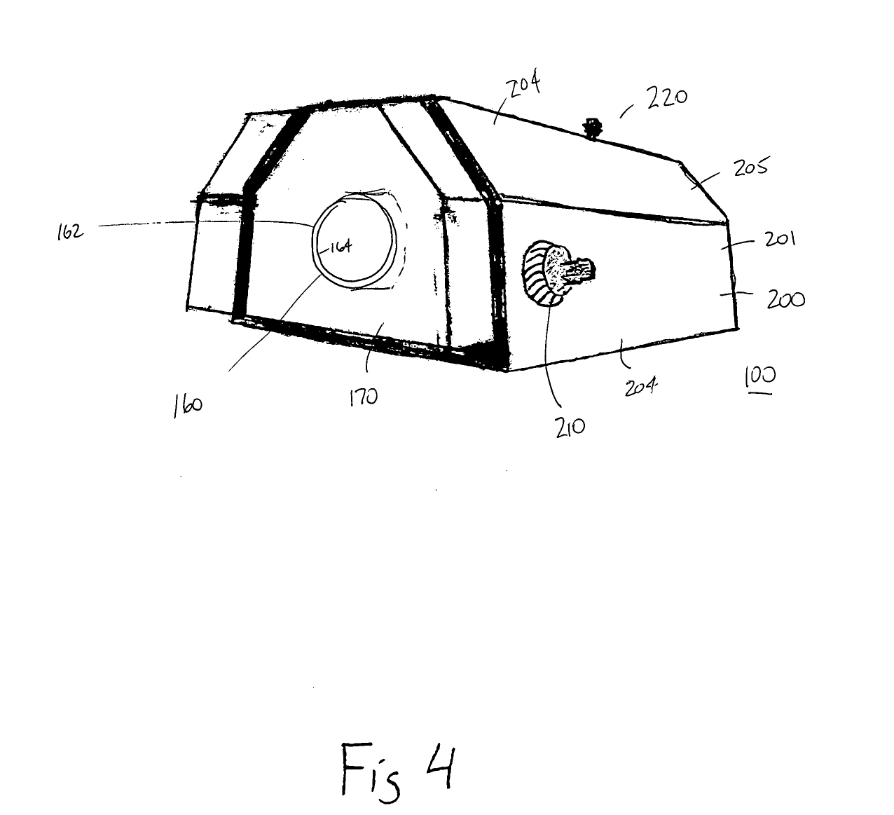

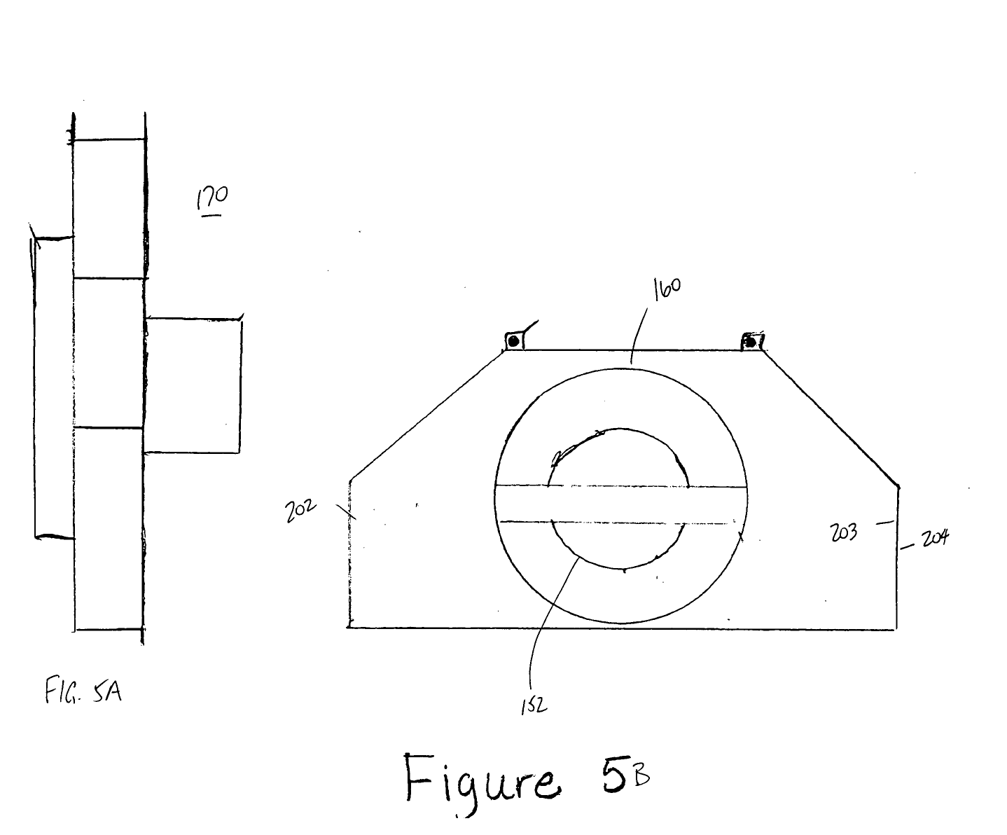

FIG. 4 is a perspective view of an example hood device 100. FIG. 5A is a top view of the first end of the hood of FIG. 4. FIG. 5B is a side view of the first end of the hood of FIG. 4. The device includes a lamp 150 (not shown) and socket 152, a housing 200 with a lid 205, a first side 201, a second side 202, an inside surface 203, and an outside surface 204; a tube 160 having an outside wall 162, and inside wall 164, a first end 170 and a second end 180; a first end seal 172, a second end seal 182; electrical supply connection 154; water supply inlet port 210; water supply exit port 220; and bottom panel 230. The bottom panel includes an outside surface 232 and an inside surface 234. The hood contains a volume of coolant 208 between the outside wall 162 of the tube, the inside surface 202 of the housing 200, and the inside surface 234 of the bottom panel 230. In this example, the lid 205 is comprised of a top portion 206 and a bottom portion 207.

This example hood has many advantages over prior art air cooled devices and over the prior art Water Jacket device.

In this example, the Hydroflector holds about 3 gallons of water, while the Water Jacket device holds about 0.5 gallon of fluid. This greater volume of coolant provides better cooling, even with lower water flow or pressure.

The Hydroflector is designed to hold water in case of pump failure, thereby protecting plants from excessive heat from the lights for a longer period of time should the pump fail, and protecting the equipment from rapid temperature change once the pump is restarted.

The Water Jacket typically drains the coolant in case of pump failure, and this loss of coolant can cause a rapid heating of the air around the lights. This heating potentially endangers pants, and increases the likelihood of jacket and bulb breakage once cold water is reintroduced.

In the unlikely event of glass tube breakage in the current invention, the glass is self-contained within the unit, thereby protecting the user from cuts and flying glass. In the water Jacket, there is no protection from broken glass.

The current invention is both watertight and water-resistant. All electrical components are protected from the water in the hood as well as from any greenhouse watering overspray. The greenhouse operator may water plants without concern about the hood.

The current invention can be either air-cooled or water-cooled.

The Hydroflector is a one-piece, no-assembly-required solution, whereas the water jacket is only one component of a two-component system.

The current invention may provide a plastic or metal port connection to coolant hoses so that it is not necessary to clamp hoses onto glass fittings of prior art devices. Prior art devices with glass connections are prone to break at the connection.

The water-cooled embodiment of the current invention permits a customer use twice as many hoods within the same area as an air-cooled system. With the Hydroflector, the customer has the option of putting two light bulbs under one hood, resulting in greater light output, or greater spectrum range. The water jacket, within the same area, supports a single bulb. The water-cooled system allows plants to be much closer to the light source than air-cooled systems, typically as close as 12″ in some cases versus 36″ for most air-cooled systems.

### Air Cooled Hood

The cooling hood described above can be operated with coolants other than water. In one example, air is used as the coolant, and air is delivered to the inlet port. Warm air exits the hood through the exit port, and is typically directed outside of a greenhouse or other grow area.

### Water Cooled Hood

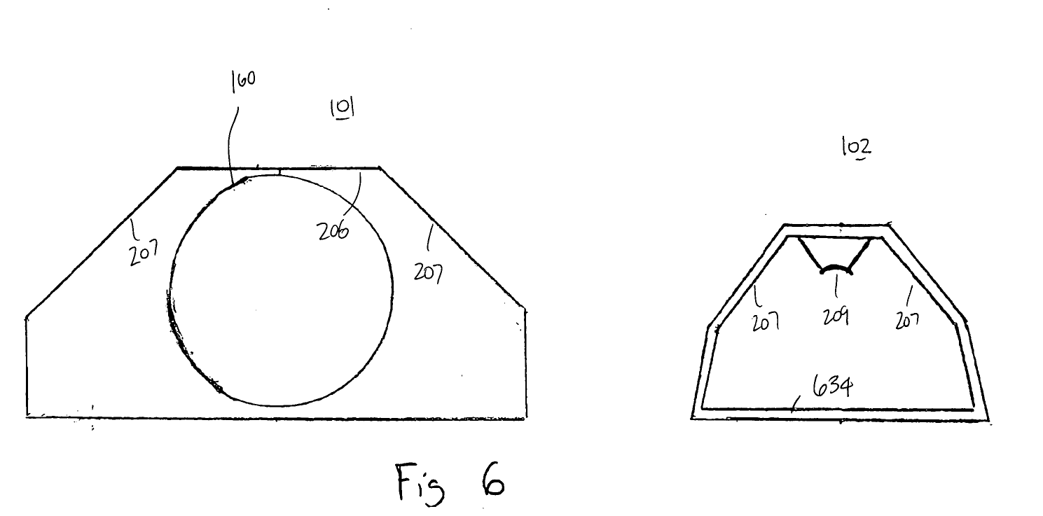

FIG. 6 is a cross section view showing a variety of shapes 101 and 102 for the hood housing. The hood shape may be selected for a desired profile for coolant volume or light reflection. In one example, the profile is selected to provide an efficient reflective surface so that the upper lid portion 206 and lower lid portion 207 may redirect light from the top of the lamp to a plant growing area. The angles and sizes of the lid portion can be selected to provide the desired reflective characteristics The reflective pattern may be large or small, depending on the plant growth objective. For instance, a commercial operation may desire to spread light, while an individual hobbyist may desire to focus light on a singe rose plant. The angle of the hood lid and sides, and optional insert reflectors 209 typically determine the reflective characteristics of the device.

### Air Cooled Hood

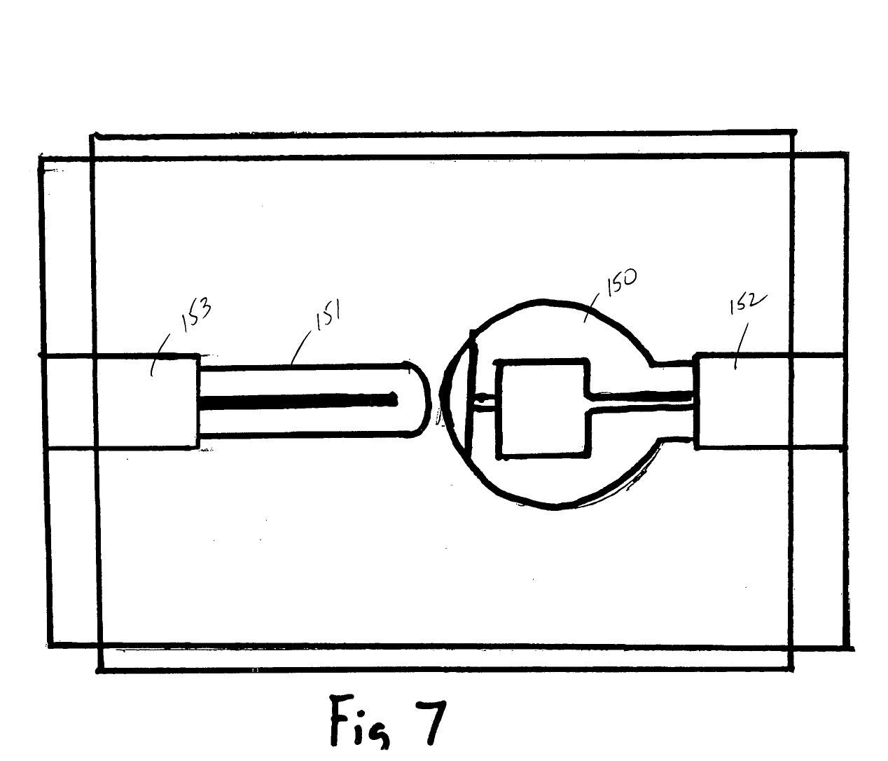

FIG. 7 is a perspective view of an example hood device with two light bulbs 150 and 151. Bulb 150 is inserted into socket 152, and bulb 151 is inserted into socket 153. In this case, the bulbs may be the same type of lamp or may have different wavelength characteristics. Each bulb is easily installed or replaced such as by removing an end cap or portion of end cap to access the light socket.

### Double Cylinder Coolant Device

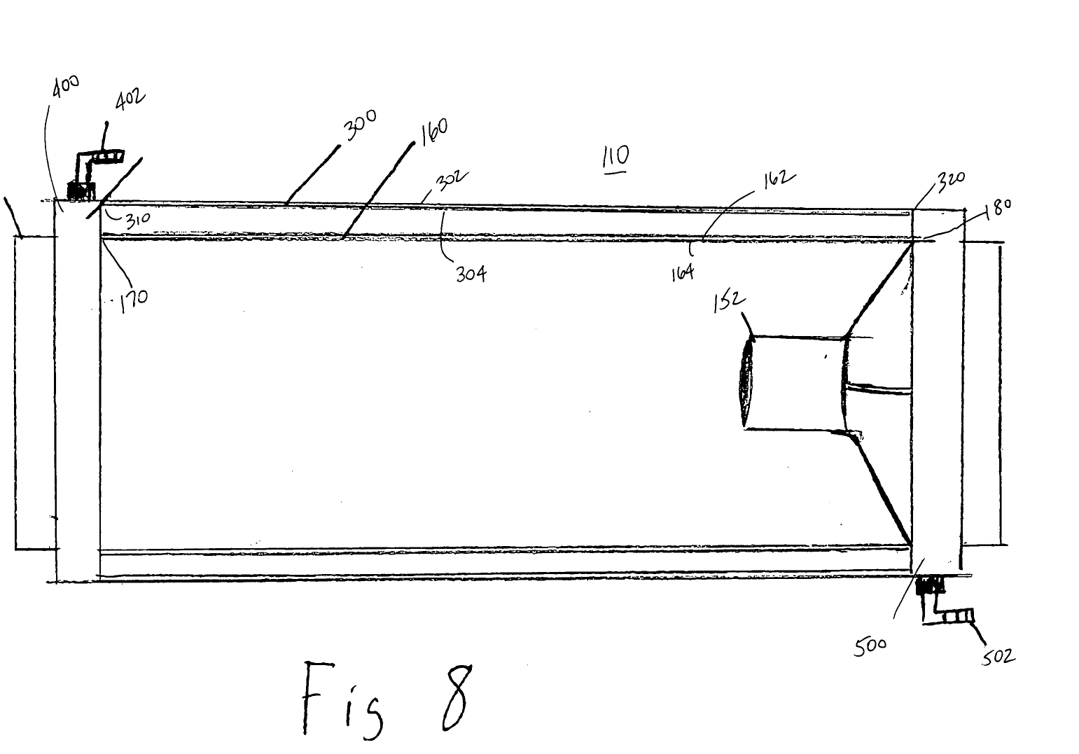

FIG. 8 is a perspective view of a double cylinder coolant device 110. In this example, the device includes a lamp 150 (not shown) in socket 152; an inner tube 160 with an outside wall 162, an inside wall 164, a first end 170, and a second end 180; an outer tube 300 with an outside wall 302, an inside wall 304, a first end 310, and a second end 320; a first end cap 400 with an inlet port 402, an inner tube seal 410 (not shown), and an outer tube seal 420 (not shown); a second end cap 500, with an inlet port 502, an inner tube seal 510 (not shown), and an outer tube seal 520 (not shown). A volume of coolant 207 (not shown) is contained between the inner tube and the outer tube.

The inner tube 160 and the outer tube 300 may be formed by cutting glass tubes to a desired length.

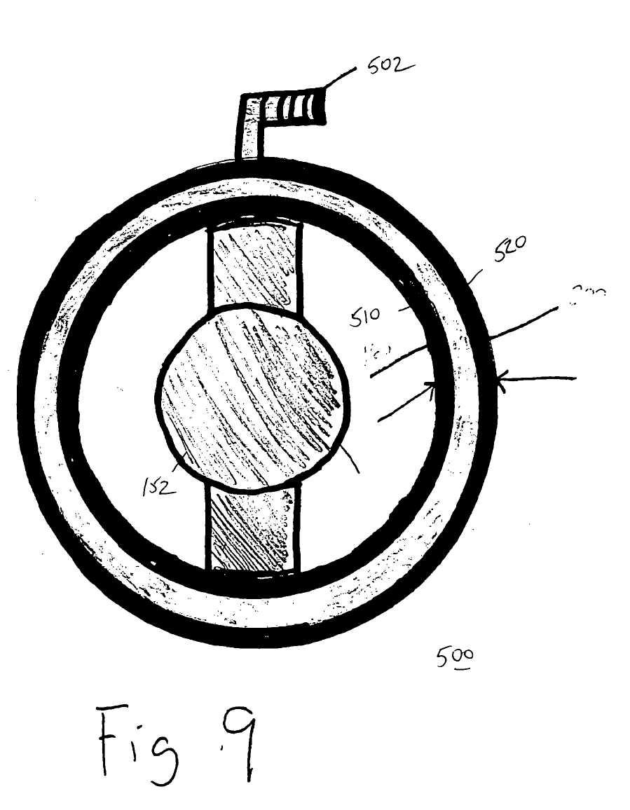

FIG. 9 is a front view of an end cap 500 for the double cylinder coolant device of FIG. 8. Removing the end cap provides access to socket 152 to replace the light bulb. Return port 502 may include a pressure relief valve. The end cap includes inner tube seal 510, and outer tube seal 520. Each end cap typically includes one or more bracket for hanging the hood. The end cap is typically metal, but may be provided in other materials such as a high temperature plastic.

Many alterations and modifications of these example devices will be apparent to those skilled in the art, and the scope of the invention is to be construed in accordance with the claims.

### Water or Air Cooled Hood

Another embodiment of the current invention is the Hydroflector™ hood. This embodiment provides a lighter weight hood device which has many of the advantages described above. In this example, the hood device holds approximately 1 gallon of water coolant, or it may be cooled by air flow.

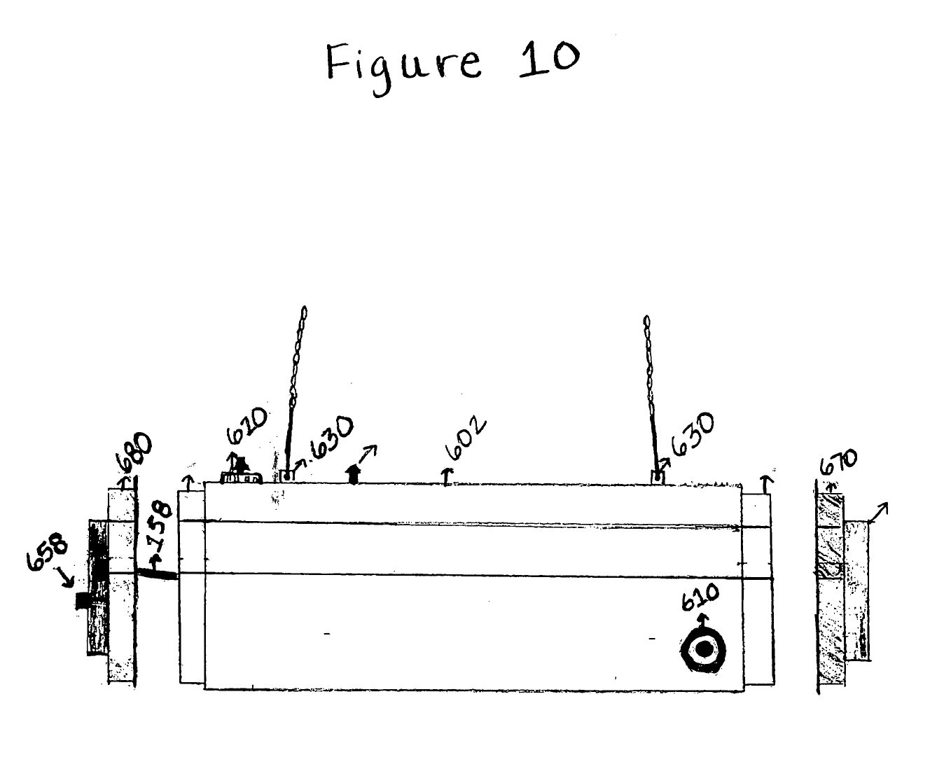

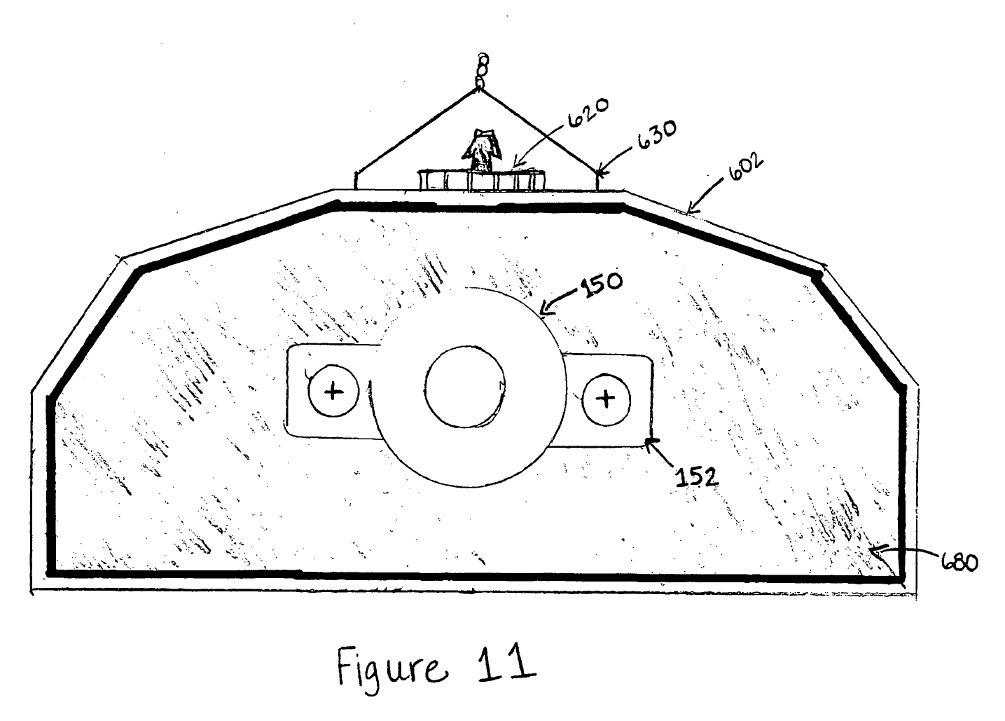

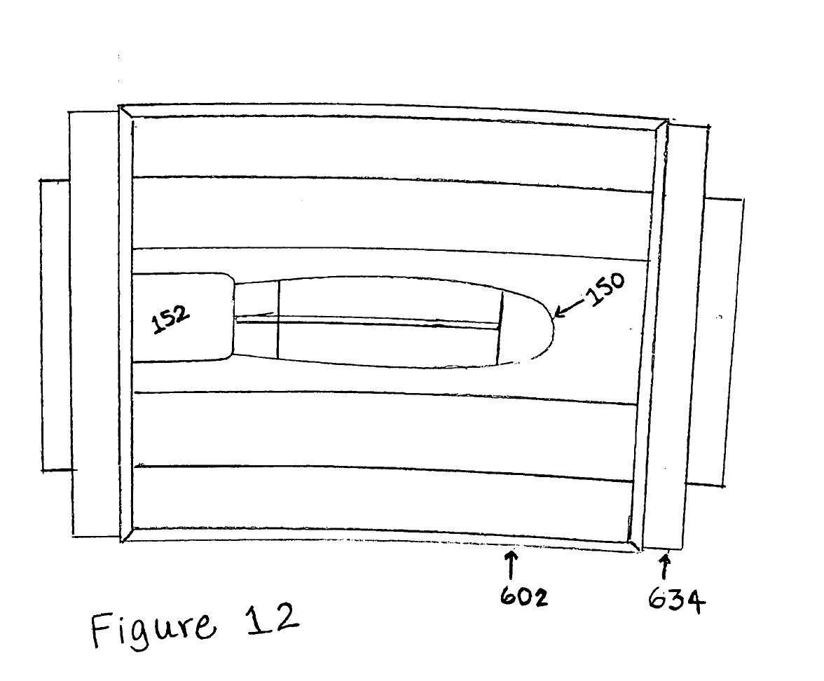

FIG. 10 is a side view of the hood device; FIG. 11 is a cross section view of the hood device; and FIG. 12 is a bottom view of the hood device. The hood 600 comprises a hood body 602 which includes chain support hangers 630. A first end cap 680 includes a light power cord watertight connection 658. A light power cord 158 is provided through the watertight connection to a light socket and bracket 152 for high intensity bulb 150. A second end cap 670 is provided on the other end of the tube device. During liquid cooling, these end caps are sealed against the housing. A coolant flow is provided through water supply port 610 and water return port 620. This coolant flow is typically a recirculating water system which may include a radiator or heat exchanger to remove heat to an area away from the plants. A pressure relief valve 680 may be provided in order to vent a high pressure before the pressure can break or cause leakage to the hood.

The hood may also be air cooled by removing the end caps. End caps 6 inch hole for air cooling. Insulation is provided in the end caps.

To use the device as an air cooled hood, end caps can be removed from the inner tube, which is typically 6 inches in diameter. A first duct is connected to one end of the tube, and to a fan. The second end of the tube may be left open to vent air into a room such as a greenhouse, or a second duct may be attached to direct the exit air out of the room. It is possible to operate the unit as both an air cooled and water cooled device at the same time.

The bottom of the hood is a glass insert 634. The hood provides improved maintenance access. Dirt may be removed from the inner housing and outer housing, to improve optical transmission.

### Controls

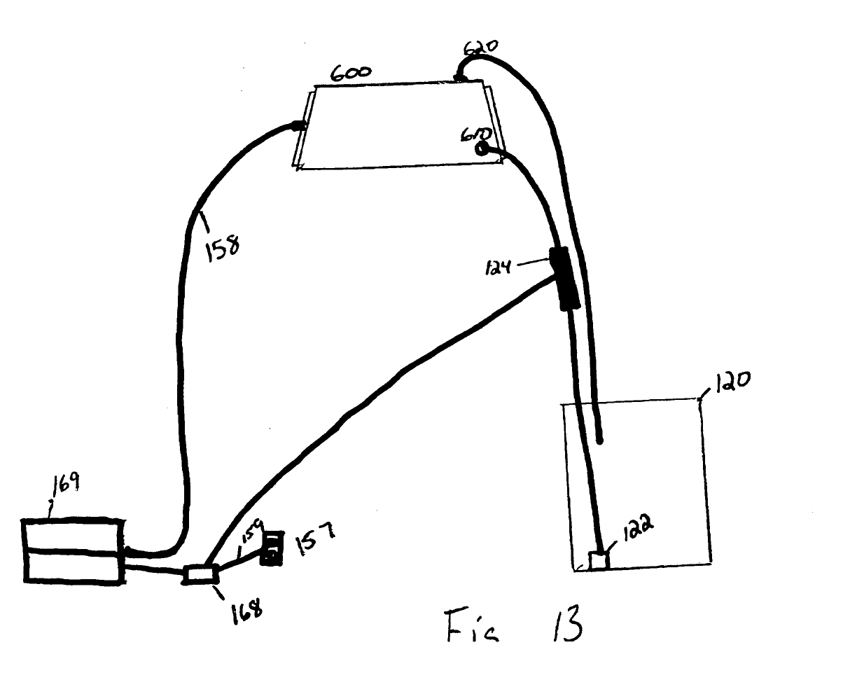

FIG. 13 is a schematic showing fluid and electrical connections to a hood and coolant recirculation system. In this example, the hood 600 is supplied by a water coolant through inlet port 610. Coolant exits the hood through return port 620 and flows back to a reservoir 120 with pump 122. An optional heat exchange device may be provided in this loop. A flow sensor 124 is provided in the coolant loop. A cord 159 is plugged into a power receptacle 157 and runs to a control unit 168 and then to ballast 169 and to the hood light socket. The flow sensor sends a signal to the control unit so that if coolant flow is interrupted, the control unit cuts off power to the hood.

What is claimed is:

1. A light bulb cooling hood comprising:
a housing comprising
a first side,
a second side,
an inside surface,
a coolant fluid supply inlet port, and
a coolant fluid supply exit port;
a transparent bottom panel;
a tube comprising
a first end projected through the first side of the housing,
a first end seal,
a second end projected through the second side of the housing, and
a second end seal,
at least one light bulb positioned within the tube, such that at least a portion of the tube in proximity to the bulb is transparent.

2. The light bulb cooling hood of claim 1 wherein the inside surface of the housing further comprises
a reflective material, such that the reflective material reflects light from the bulb toward the transparent bottom panel.

3. The light bulb cooling hood of claim 1 further comprising
a pressure relief valve.

4. The light bulb cooling hood of claim 1 further comprising
a plurality of internal reflective surfaces.

5. The light bulb cooling hood of claim 1 further comprising
at least one reflector.

6. The light bulb cooling hood of claim 1 further comprising
at least one hanging bracket.

7. A light bulb cooling system comprising
a light bulb cooling hood comprising:
a housing comprising
a first side,
a second side,
an inside surface,
a coolant fluid supply inlet port, and
a coolant fluid supply exit port,
a transparent bottom panel,
a tube comprising
a first end projected through the first side of the housing,
a first end seal,
a second end projected through the second side of the housing, and
a second end seal,
at least one light bulb positioned within the tube, such that at least a portion of the tube in proximity to the bulb is transparent;
coolant;
a coolant reservoir;
a coolant pump; and
tubing, such that the tubing delivers the coolant from the pump to the hood, and from the hood to the reservoir.

8. The light bulb cooling system of claim 7 further comprising
a coolant chiller.

9. The light bulb cooling system of claim 7 further comprising
a fan, and
an air supply duct from the fan to the first end of the tube.

10. The light bulb cooling system of claim 7 further comprising
a pressure relief valve.

11. The light bulb cooling system of claim 7 further comprising
a plurality of internal reflective surfaces.

12. The light bulb cooling system of claim 7 further comprising
at least one reflector.

13. The light bulb cooling system of claim 7 further comprising
at least one flow control device.

14. The light bulb cooling system of claim 7 further comprising
at least one hanging bracket.

15. The light bulb cooling system of claim 7 further comprising
a flow check valve.

16. The light bulb cooling system of claim 7 further comprising
a temperature sensor; and
a controller, in communication with the temperature sensor, such that the controller provides a control of the amount of coolant flow from the pump based on the communication from the temperature sensor.

17. A light bulb cooling device comprising:
an outer tube comprising
a transparent lower portion,
a coolant fluid supply inlet port, and
a coolant fluid supply exit port;
an inner tube comprising
a first end, and
a second end;
a first end cap, such that the first end cap provides a seal between the first end of the inner tube and the first end of the outer tube;
a second end cap, such that the second end cap provides a seal between the second end of the inner tube and the second end of the outer tube, so that an annular volume of coolant may be maintained between the inner tube, the outer tube, the first end cap, and the second end cap; and
at least one light bulb positioned within the inner tube, such that at least a portion of the tube in proximity to the bulb is transparent.

18. The light bulb cooling device of claim 17 wherein the outer tube further comprises
a reflective material, such that the reflective material reflects light from the bulb.

19. The light bulb cooling device of claim 17 further comprising
a pressure relief valve.

20. The light bulb cooling device of claim 17 further comprising
at least one hanging bracket.
